(19) United States
(12) Patent Application Publication
(10) Pub. No.: US 2021/0370277 A1
(43) Pub. Date: Dec. 2, 2021

(54) PROCESS FOR THE PREPARATION OF ZEOLITES ENCAPSULATING TRANSITION METAL NANOPARTICLES FROM LAYERED SILICATE PRECURSORS

(71) Applicant: BASF SE, Ludwigshafen am Rhein (DE)

(72) Inventors: Robert MCGUIRE, Florham Park, NJ (US); Mathias FEYEN, Ludwigshafen (DE); Ulrich MUELLER, Ludwigshafen (DE); Weiping ZHANG, Dalian City (CN)

(73) Assignee: BASF SE, Ludwigshafen am Rhein (DE)

(21) Appl. No.: 16/759,838

(22) PCT Filed: Oct. 24, 2018
(86) PCT No.: PCT/CN2018/111618

§ 371 Date: Apr. 28, 2020

(30) Foreign Application Priority Data
Oct. 30, 2017 (CN) PCT/CN2017/108259

(51) Int. Cl. B01J 29/67; C01B 39/44; C01B 39/02; B01J 37/18; B01J 37/08; B01J 35/00; B01J 35/10

(52) U.S. Cl. CPC B01J 29/67; C01B 39/445; C01B 39/026; B01J 37/18; B01J 37/082; C01P 2004/04; B01J 35/1019; B01J 2229/34; B01J 2229/18; C01P 2002/72; B01J 35/006

(57) ABSTRACT

The present invention relates to a process for the production of a transition metal containing zeolite comprising expanding a layered silicate with a swelling agent and introducing the transition metal into the interlayer expanded silicate prior to calcination thereof for obtaining the transition metal containing zeolite. The present invention further relates to a zeolite containing transition metal nanoparticles as obtainable or obtained according to the inventive process, as well as to a zeolite containing nanoparticles per se. Finally the present invention relates to the use of a zeolite containing transition metal nanoparticles as obtainable or obtained according to the inventive process, as well as to the use of a zeolite containing nanoparticles per se.

### TECHNICAL FIELD

The present invention relates to a process for the production of a transition metal containing zeolite comprising expanding a layered silicate with a swelling agent and introducing the transition metal into the interlayer expanded silicate prior to calcination thereof for obtaining the transition metal containing zeolite. The present invention further relates to a zeolite containing transition metal nanoparticles as obtainable or obtained according to the inventive process, as well as to a zeolite containing nanoparticles per se. Finally the present invention relates to the use of a zeolite containing transition metal nanoparticles as obtainable or obtained according to the inventive process, as well as to the use of a zeolite containing nanoparticles per se.

### INTRODUCTION

Metal nanoparticles in zeolites are very intriguing catalysts as their distinct selectivity and activity for various types of catalytic reactions. Therefore, a variety of approaches have been developed to prepare the metal nanoparticles in zeolites. For large-pore zeolites with 12-membered ring (MR) structures such as FAU, MOR, LTL, BEA, AFI, etc., encapsulation of metal nanoparticles in the cages or channels has been generally achieved by introducing metal precursors after zeolite crystallization using ion-exchange, impregnation, or chemical vapor deposition. For smaller-pore zeolites with 10 or 8-MR structures, the above mentioned methods are not so efficient due to the smaller apertures. This problem has been well addressed by introducing metal precursor or nanoparticles during zeolite crystallization process, and the metal precursors or nanoparticles were embedded in the zeolite crystals during their crystallization. Thus, metal nanoparticles such as Au, Ag, Pt, Pd, Ru, and Rh were introduce in MFI, SOD, BEA, FAU zeolites using metal complex or synthesized nanoparticles during crystallization of zeolite. Despite the development of such methods, the efficient introduction of metal nanoparticles is still challenging. In particular, charge densities, pore sizes of zeolites and stability/size of the metal precursor have great impact on the efficiency of encapsulation.

All of the aforementioned investigations are focused on the 3-dimensional framework zeolites. Some zeolites such as MCM-22, Ferrierite, Sodalite, RUB-24, CDS-1(RUB-37), RUB-41, etc. can be obtained from their layered precursors MCM-22P, PREFER, RUB-15, RUB-18, PLS-1(RUB-36), RUB-39, respectively. These layered precursors have a flexible layer distance which may be expanded with the aid of swelling agents. Thus, Z. Zhao et al., Chem. Mater, 2013, 25, 840-847 concern the interlayer expansion of lamellar precursors of CDO and FER-type zeolites using cetyltrimethylammonium hydroxide (CTAOH) as the swelling agent. As such, interlayer expanded silicates prove to be candidates for the introduction of the guest metal precursors and/or metal nanoparticles. Thus, in L. Liu et al., Nat Mater, 2017, 16, 132-138, subna-nometric Pt clusters were prepared using dimethyl formamide as a weak reduction and capping agent during transformation of a 2D zeolite into 3D high silica MCM-22 zeolite. However, the yield of the reaction is low, and the amount of encapsulated Pt is lower than 0.2 wt.-%.

Thus, despite the progress made with regard to the introduction of metal nanoparticles into zeolites, there remains a need for a process which is able to incorporate larger amounts of metal nanoparticles, in particular in medium and small pore zeolites.

### DETAILED DESCRIPTION

It was therefore an object of the present invention to provide an improved process for preparing a transition metal nanoparticle containing zeolite, in particular having medium and small pore sizes. Thus, it has surprisingly been found that by employing cationic transition metal complexes in a process for the interlayer expansion and deswelling of a layered silicate with the aid of a swelling agent, zeolites having very high loadings of the transition metal nanoparticles encapsulated therein may be obtained.

Therefore, the present invention relates to a process for the production of a transition metal containing zeolite comprising:
(i) providing a layered silicate;
(ii) treating the layered silicate provided in (i) with one or more swelling agents and obtaining an interlayer expanded silicate;
(iii) treating the interlayer expanded silicate obtained in (ii) with one or more cationic transition metal complexes and obtaining a transition metal containing interlayer expanded silicate;
(iv) calcining the transition metal containing interlayer expanded silicate obtained in (iii) and obtaining a transition metal containing zeolite;
(v) optionally reducing the transition metal containing zeolite obtained in (iv);
   wherein the framework structure of the zeolite obtained in (iv) comprises YO₂ and optionally X₂O₃, wherein Y is a tetravalent element, and X is a trivalent element.

In the context of the present invention Y may be any tetravalent element. Preferably, Y is selected from the group consisting of Si, Sn, Ti, Zr, Ge, and mixtures of two or more thereof, Y preferably being Si.

In the context of the present invention X may be any trivalent element. Preferably, X is selected from the group consisting of Al, B, In, Ga, and mixtures of two or more thereof, X preferably being Al.

As to step (i), it is conceivable that any layered silicate may be provided. Preferably, the layered silicate provided in (i) is a layered aluminosilicate, titanosilicate, or borosilicate, preferably a layered aluminosilicate or titanosilicate, and more preferably a layered aluminosilicate. Preferably, the layered silicate provided in (i) is selected from the group consisting of MCM-22P, PREFER, Nu-6(2), PLS-3, PLS-4, MCM-47, ERS-12, MCM-65, RUB-15, RUB-18, RUB-20, RUB-36, RUB-38, RUB-39, RUB-40, RUB-42, RUB-51, BLS-1, BLS-3, ZSM-52, ZSM-55, kanemite, makatite, magadiite, kenyaite, revdite, montmorillonite, and mixtures of two or more thereof, more preferably from the group consisting of PREFER, MCM-47, ERS-12, PLS-3, RUB-36, PLS-4, MCM-22P, RUB-15, RUB-18, RUB-39, and mixtures of two or more thereof.

The abbreviation RUB-36 as used herein is synonymous with PLS-1. The abbreviation RUB-37 as used herein is synonymous with CDS-1. As regards the preparation and characterization of the layered silicates BLS-1 and BLS-3, reference is made to WO 2010/100191 A1, the contents of which are incorporated herein by reference.

Regarding the specific layered silicates defined in the foregoing, RUB-15 relates to a specific type of layered silicates of which the preparation is, for example, disclosed in U. Oberhage-mann, P. Bayat, B. Marler, H. Gies, and J. Rius Angew. Chem., Intern. Ed. Engl. 1996, 35, pp. 2869-2872. RUB-18 refers to specific layered silicates of which the preparation is, for example, described in T. Ikeda, Y. Oumi, T. Takeoka, T. Yokoyama, T. Sano, and T. Hanaoka Microporous and Mesoporous Materials 2008, 110, pp. 488-500. RUB-20 relates to specific layered silicates which may be prepared as, for example, disclosed in Z. Li, B. Marler, and H. Gies Chem. Mater. 2008, 20, pp. 1896-1901. RUB-36 refers to specific silicates of which the preparation is, for example, described in J. Song, H. Gies Studies in Surface Science and Catalysis 2004, 15, pp. 295-300. RUB-39 relates to specific layered silicates of which the preparation is, for example, described in WO 2005/100242 A1, in particular in Examples 1 and 2 on pages 32 and 33, in WO 2007/042531 A1, in particular in Example 1 on page 38, Example 2 on page 39, Example 3 on page 40, Example 6 on page 41, and Example 7 on page 42, or WO 2008/122579 A2, in particular in Example 1 on page 36 and in Example 3 on page 37, respectively. RUB-51 refers to specific layered silicates of which the preparation is, for example, described in Z. Li, B. Marler, and H. Gies Chem. Mater. 2008, 20, pp. 1896-1901. ZSM-52 and ZSM-55 refer to specific layered silicates which may be prepared as, for example, described in D. L. Dorset, and G. J. Kennedy J. Phys. Chem. B. 2004, 108, pp. 15216-15222. Finally, RUB-38, RUB-40, and RUB-42 respectively refer to specific layered silicates as, for example, presented in the presentation of B. Marler and H. Gies at the 15^{th} International Zeolite Conference held in Beijing, China in August 2007.

In particular, according to more preferred embodiments of the present invention, wherein the layered silicate provided in (i) comprises RUB-36, it is further preferred that the RUB-36 has an X-ray diffraction pattern comprising at least the following reflections:

| Diffraction angle 2θ/° [Cu K(alpha 1)] | Intensity (%) |
|---|---|
| 7.85-8.05 | 100.0 |
| 17.04-17.24 | 1.6-5.6 |
| 20.26-20.46 | 1.7-5.7 |
| 23.89-24.09 | 4.2-12.2 |
| 24.73-24.93 | 4.8-12.8 |
| 25.30-25.50 | 2.6-6.6 |
| 26.52-26.72 | 0.7-4.7 |

wherein 100% relates to the intensity of the maximum peak in the X-ray diffraction pattern.

In particular, according to more preferred embodiments of the present invention, wherein the layered silicate provided in (i) comprises RUB-39, it is further preferred that the RUB-39 has an X-ray diffraction pattern comprising at least the following reflections:

| Diffraction angle 2θ/° [Cu K(alpha 1)] | Intensity (%) |
|---|---|
| 8.15-8.35 | 100.0 |
| 16.39-16.59 | 2-12 |
| 19.87-20.07 | 7-17 |
| 23.41-23.61 | 9-19 |
| 29.94-30.14 | 1-11 |
| 35.90-36.10 | 0.5-10 |

wherein 100% relates to the intensity of the maximum peak in the X-ray diffraction pattern.

Preferably, the layered silicate provided in (i) is selected from the group consisting of PREFER, MCM-47, ERS-12, PLS-3, RUB-36, PLS-4, and mixtures of two or more thereof, wherein more preferably the layered silicate comprises RUB-36, wherein more preferably the layered silicate is RUB-36.

The transition metal containing zeolite obtained in (iv) may be any transition metal containing zeolite. Preferably, the transition metal containing zeolite obtained in (iv) is of the FER or CDO framework type, wherein more preferably the zeolite is of the FER framework type, wherein more preferably the zeolite obtained in (iv) is ZSM-35. It is alternatively preferred that the layered silicate provided in (i) is RUB-15 and the transition metal containing zeolite is of the SOD framework type, wherein more preferably the zeolite obtained in (iv) is sodalite. It is alternatively preferred that the layered silicate provided in (i) is RUB-18 and the transition metal containing zeolite is of the RWR framework type, wherein more preferably the zeolite obtained in (iv) is RUB-24. It is alternatively preferred that the layered silicate provided in (i) is RUB-36 and the transition metal containing zeolite is of the CDO framework type, wherein more preferably the zeolite obtained in (iv) is RUB-37.

In the context of the present invention, it is alternatively preferred that the layered silicate provided in (i) is RUB-39 and the transition metal containing zeolite is of the RRO framework type, wherein more preferably the zeolite obtained in (iv) is RUB-41. Another preferred alternative is that the layered silicate provided in (i) is MCM-22P and the transition metal containing zeolite is of the MWW framework type, wherein more preferably the zeolite obtained in (iv) is MCM-22.

The transition metal containing zeolite obtained in (iv) is preferably of the framework type selected from the group consisting of FER, MWW, SOD, RWR, CDO, and RRO, wherein more-preferably the zeolite is of the FER or MWW framework type, wherein more preferably the zeolite is of the FER framework type. Preferably, the transition metal containing zeolite is selected from the group consisting of ZSM-35, sodalite, RUB-24, RUB-37, RUB-41, and MCM-22, wherein more preferably the zeolite is ZSM-35 or MCM-22, wherein more preferably the zeolite is ZSM-35.

As to step (ii), preferably the treatment in (ii) comprises
(ii.a) adding the layered silicate to an aqueous solution containing one or more swelling agents, stirring the resulting mixture, and obtaining an interlayer expanded silicate;
(ii.b) optionally isolating the interlayer expanded silicate obtained in (ii.a), preferably by filtration; and
(ii.c) optionally washing the interlayer expanded silicate obtained in (ii.a) or (ii.b), preferably in (ii.b); and/or, preferably and
(ii.d) optionally drying the interlayer expanded silicate obtained in (ii.a), (ii.b) or (ii.c), preferably in (ii.c);
   wherein the steps (ii.b) and/or (ii.c) and/or (ii.d) can be conducted in any order, and
   wherein optionally one or more of said steps is repeated one or more times;
   and wherein the treatment in (iii) comprises
(iii) treating the interlayer expanded silicate obtained in (ii.a), (ii.b), (ii.c), or (ii.d), preferably in (ii.d), with one or more cationic transition metal complexes and obtaining a transition metal containing interlayer expanded silicate.

The one or more swelling agents used in (ii) or (ii.a) preferably comprise one or more compounds selected from the group consisting of surfactants and mixtures thereof, more preferably from the group consisting of cationic surfactants and mixtures thereof, more preferably from the group consisting of quaternary ammonium cations and salts thereof, more preferably from the group consisting of alkyltrimethylammonium compounds, alkylethyldimethylammonium compounds, alkyldiethylmethylammonium compounds, alkyltriethylammonium compounds, and mixtures of two or more thereof, more preferably from the group consisting of alkyltrimethylammonium compounds, alkylethyldimethylammonium compounds, and combinations of two or more thereof, wherein more preferably the one or more swelling agents used in (ii) or (ii.a) comprise one or more alkyltrimethylammonium compounds, wherein more preferably the one or more swelling agents is one or more alkyltrimethylammonium compounds. Preferably, the alkyl group is selected from the group consisting of C₄-C₂₆ alkyl chains, more preferably from the group consisting of C₆-C₂₄ alkyl chains, more preferably of C₈-C₂₂ alkyl chains, more preferably of C₁₀-C₂₀ alkyl chains, more preferably of C₁₂-C₁₈ alkyl chains, more preferably of C₁₄-C₁₈ alkyl chains, more preferably of C₁₅-C₁₇ alkyl chains, wherein more preferably the alkyl group is a C₁₆ alkyl chain.

Preferably, the one or more swelling agents used in (ii) or (ii.a) comprise one or more cetyltrimethylammonium salts, wherein the counterion is preferably selected from the group consisting of halides, hydroxide, carboxylates, nitrate, nitrite, sulfate, and mixtures of two or more thereof, more preferably from the group consisting of fluoride, chloride, bromide, hydroxide, nitrate, and mixtures of two or more thereof, more preferably from the group consisting of chloride, bromide, hydroxide and mixtures of two or more thereof, wherein more preferably the one or more swelling agents used in (ii) or (ii.a) comprise cetyltrimethylammonium hydroxide, wherein more preferably the one or more swelling agents used in (ii) or (ii.a) is cetyltrimethylammonium hydroxide.

If step (ii.a) is carried out, preferably stirring in (ii.a) is performed for a duration in the range of from 1 to 168 h, preferably from 3 to 144 h, more preferably from 6 to 120 h, more preferably from 12 to 96 h, more preferably from 24 to 72 h, more preferably from 36 to 60 h, more preferably from 42 to 54 h, and more preferably from 46 to 50 h.

If step (ii.c) is carried out, preferably washing in (ii.c) is performed with a solvent system comprising water, preferably with water, and more preferably with distilled water.

If step (iia) and/or (iid) are carried out, preferably stirring in (ii.a) and/or drying in (ii.d), more preferably stirring and drying, are performed at a temperature in the range of from 20 to 70° C., preferably from 20 to 50° C., more preferably from 20 to 45° C., more preferably from 25 to 40° C., more preferably from 25 to 35° C., and more preferably from 25 to 30° C.

As to step (iii), it is conceivable that any cationic transition metal complex may be employed. Preferably, the transition metal of the one or more cationic transition metal complexes is selected from the group consisting of group 8 to 11 transition metals of the periodic table, including mixtures of two or more thereof, more preferably from the group consisting of Fe, Co, Ni, Cu, Rh, Pd, Ag, Pt, Au, and mixtures of two or more thereof, more preferably from the group consisting of Fe, Cu, Rh, Pd, Pt, and mixtures of two or more thereof, more preferably from the group consisting of Rh, Pd, Pt, and mixtures of two or more thereof, wherein more preferably the transition metal of the one or more cationic transition metal complexes comprises Pd, and wherein more preferably the transition metal of the one or more cationic transition metal complexes is Pd.

The treatment in (iii) preferably comprises
(iii.a) preparing a solution comprising one or more cationic transition metal complexes dissolved in one or more alkanols;
(iii.b) adding the interlayer expanded silicate obtained in (ii) to the solution obtained in (iii.a), stirring the resulting mixture, and obtaining a transition metal containing interlayer expanded silicate;
(iii.c) optionally isolating the a transition metal containing interlayer expanded silicate obtained in (iii.b), preferably by filtration; and
(iii.d) optionally washing the transition metal containing interlayer expanded silicate obtained in (iii.b) or (iii.c), preferably in (iii.c); and/or, preferably and
(iii.e) optionally drying the transition metal containing interlayer expanded silicate obtained in (iii.b), (iii.c) or (iii.d), preferably in (iii.d);
   wherein the steps (iii.c) and/or (iii.d) and/or (iii.e) can be conducted in any order, and
   wherein optionally one or more of said steps is repeated one or more times;
   and wherein the treatment in (iv) comprises
(iv) calcining the transition metal containing interlayer expanded silicate obtained in (iii.b), (iii.c), (iii.d), or (iii.e), preferably in (ii.e), and obtaining a transition metal containing zeolite.

As to step (iii), the one or more cationic transition metal complexes employed comprise ligands. Preferably, the ligands of the one or more cationic transition metal complexes are selected from the group consisting of mono-, bi-, tri-, tetra-, penta-, and hexadentate ligands, including combinations of two or more thereof, preferably from the group consisting of halide, pseudohalide, H₂O, NH₃, CO, hydroxide, oxalate, ethylenediamine, 2,2′-bipyridine, 1,10-phenanthroline, acetylacetonate, 2,2,2-crypt, diethylenetriamine, dimethylglyoximate, EDTA, ethylenediaminetriacetate, glycinate, triethylenetetramine, tris(2-aminoethyl)amine, and combinations of two or more thereof, more preferably from the group consisting of fluoride, chloride, bromide, cyanide, cyanate, thiocyanate, NH₃, CO, hydroxide, oxalate, ethylenediamine, acetylacetonate, diethylenetriamine, dimethylglyoximate, EDTA, ethylenediaminetriacetate, glycinate, triethylenetetramine, tris(2-aminoethyl)amine, and combinations of two or more thereof, more preferably from the group consisting of ethylenediamine, acetylacetonate, diethylenetriamine, EDTA, ethylenediaminetriacetate, triethylenetetramine, and combinations of two or more thereof, wherein more preferably the ligand of the one or more cationic transition metal complexes is ethylenediamine.

Preferably, the counterion of the one or more cationic transition metal complexes is selected from the group consisting of halides, hydroxide, carboxylates, nitrate, nitrite, sulfate, and mixtures of two or more thereof, more preferably from the group consisting of bromide, acetate, formate, nitrate, nitrite, sulfate, and mixtures of two or more thereof, more preferably from the group consisting of acetate, formate, nitrate, and mixtures of two or more thereof, wherein more preferably the counterion of the one or more cationic transition metal complexes comprises acetate, wherein more preferably the counterion of the one or more cationic transition metal complexes is acetate.

If step (iii.a) is carried out, preferably the one or more alkanols in (iii.a) are selected from the group consisting of methanol, ethanol, n-propanol, isopropanol, n-butanol, and mixtures of two or more thereof, more preferably from the group consisting of methanol, ethanol, isopropanol, and mixtures of two or more thereof, wherein more preferably the one or more alkanols in (iii.a) comprise ethanol, wherein more preferably ethanol is used as the one or more alkanols in (iii.a). Preferably, the solution prepared in (iii.a) further comprises excess ligands of the one or more cationic transition metal complexes, more preferably excess ligands and excess counterions of the one or more cationic transition metal complexes, and more preferably excess ligands and excess counterions, wherein the excess counterions are in the protonated form. Preferably, the solution prepared in (iii.a) further comprises water, preferably distilled water.

If step (iii.b) is carried out, preferably stirring in (iii.b) is performed for a duration in the range of from 0.5 to 12 h, preferably from 1 to 9 h, more preferably from 1.5 to 7 h, more preferably from 2 to 6 h, more preferably from 2.5 to 5.5 h, more preferably from 3 to 5 h, and more preferably from 3.5 to 4.5 h.

If step (iii.d) is carried out, washing in (iii.d) is preferably performed with a solvent system comprising water, preferably with water, and more preferably with distilled water, wherein more preferably washing is first performed with water and subsequently with a solvent selected from the group consisting of methanol, ethanol, n-propanol, isopropanol, n-butanol, and mixtures of two or more thereof, wherein more preferably washing is first performed with distilled water and subsequently with a solvent selected from the group consisting of methanol, ethanol, isopropanol, and mixtures of two or more thereof, wherein more preferably washing is first performed with distilled water and subsequently with ethanol.

If step (iii.b) and/or (iii.e) are carried out, preferably stirring in (iii.b) and/or drying in (iii.e), more preferably stirring and drying, are performed at a temperature in the range of from 20 to 70° C., preferably from 20 to 50° C., more preferably from 20 to 45° C., more preferably from 25 to 40° C., more preferably from 25 to 35° C., and more preferably from 25 to 30° C.

As to step (iv), calcining in (iv) is preferably performed at a temperature in the range of from 250 to 850° C., preferably of from 350 to 750° C., more preferably of from 450 to 650° C., more preferably of from 460 to 600° C., more preferably of from 470 to 560° C., more preferably of from 480 to 540° C., and even more preferably of from 490 to 520° C. Preferably, calcining in (iv) is performed for a duration in the range of from 0.5 to 12 h, more preferably from 1 to 9 h, more preferably from 1.5 to 7 h, more preferably from 2 to 6 h, more preferably from 2.5 to 5.5 h, more preferably from 3 to 5 h, and more preferably from 3.5 to 4.5 h.

As to step (v), reducing in (v) preferably comprises contacting the transition metal containing zeolite obtained in (iv) with a reducing agent, preferably with H₂, more preferably with a gas containing one or more inert gases and hydrogen, wherein hydrogen is contained in the gas in an amount in the range of from 1 to 95 vol.-%, preferably of from 5 to 80 vol.-%, more preferably of from 10 to 60 vol.-%, more preferably of from 15 to 50 vol.-%, more preferably of from 20 to 40 vol.-%, more preferably of from 25 to 35 vol.-%,

and wherein the one or more inert gases is preferably selected from the group consisting of noble gases, CO₂, N₂, and mixtures of two or more thereof, more preferably from the group consisting of He, Ar, N₂, and mixtures of two or more thereof, wherein more preferably the one or more inert gases comprise N₂, wherein more preferably the one or more inert gases is N₂, wherein more preferably the gas consists of one or more inert gases and hydrogen.

Preferably, (v) is performed at a temperature in the range of from 250 to 850° C., preferably of from 350 to 750° C., more preferably of from 450 to 650° C., more preferably of from 460 to 600° C., more preferably of from 470 to 560° C., more preferably of from 480 to 540° C., and even more preferably of from 490 to 520° C. Reducing in (v) is preferably performed for a duration in the range of from 0.1 to 12 h, preferably from 0.25 to 8 h, more preferably from 0.5 to 5 h, more preferably from 0.75 to 3 h, more preferably from 1 to 2 h, more preferably from 1 to 1.5 h, and more preferably from 1 to 1.25 h.

The present invention further relates to a transition metal containing zeolite obtainable and/or obtained according to the process described herein above.

Further, the present invention relates to a zeolite containing transition metal nanoparticles, preferably obtainable and/or obtained according to the process of any of embodiments 1 to 36, wherein the framework structure of the zeolite comprises YO₂ and optionally X₂O₃, wherein Y is a tetravalent element, and X is a trivalent element, and wherein the micropores of the zeolite contain 0.15 to 5 wt.-% of the transition metal nanoparticles calculated as the metal element and based on 100 wt.-% of the total weight of X, Y, O, and of the transition metal contained in the zeolite calculated as the respective element, wherein the mean particle size d50 of the transition metal nanoparticles is in the range of from 0.5 to 4 nm, and wherein the transition metal is selected from groups 8 to 11 of the periodic table, including mixtures and/or alloys of two or more thereof.

The wt.-% as used herein is preferably as determined by Inductively coupled plasma atomic emission spectroscopy (ICP-AES)

Preferably, the micropores of the zeolite contain 0.2 to 4 wt.-% of the transition metal nanoparticles calculated as the metal element and based on 100 wt.-% of the total weight of X, Y, O, and of the transition metal contained in the zeolite calculated as the respective element, more preferably 0.4 to 3 wt.-%, more preferably 0.6 to 2.5 wt.-%, more preferably 0.8 to 2.2 wt.-%, more preferably 1 to 1.9 wt.-%, more preferably 1.1 to 1.7 wt.-%, more preferably 1.2 to 1.6 wt.-%, and more preferably 1.3 to 1.5 wt.-%.

Preferably, the mean particle size d50 of the transition metal nanoparticles is in the range of from 0.8 to 3 nm, more preferably of from 1 to 2.5 nm, more preferably of from 1.1 to 2 nm, more preferably of from 1.2 to 1.7 nm, and more preferably of from 1.3 to 1.5 nm.

There are no specific restrictions on the particle size d90 of the transition metal nanoparticles. Preferably, the particle size d90 of the transition metal nanoparticles is in the range of from 1 to 7 nm, preferably of from 1.1 to 5 nm, more preferably of from 1.2 to 4 nm, more preferably of from 1.3 to 3 nm, more preferably of from 1.4 to 2.5 nm, more preferably of from 1.5 to 2 nm, and more preferably of from 1.6 to 1.8 nm.

Furthermore, there are no specific restrictions on the particle size d10 of the transition metal nanoparticles. Preferably, the particle size d10 of the transition metal nanoparticles is in the range of from 0.3 to 2.5 nm, preferably of from 0.5 to 2 nm, more preferably of from 0.6 to 1.5 nm, more preferably of from 0.7 to 1.3 nm, more preferably of from 0.8 to 1.2 nm, and more preferably of from 0.9 to 1.1 nm.

The mean particle size d50 as well as the particle sizes d90 and d10 as used herein may readily be measured by known methods, preferably by Transmission Electron Microscopy (TEM), preferably by analysis of a 100×100 nm area in the TEM image of a given sample, more preferably by measuring the size (diameter) of the particles within said area, preferably within a margin of error of ±0.2 nm, preferably wherein the threshold for the determination of the particles was a size of 0.8 nm, wherein more preferably TEM images were recorded on Hitachi HT 7700 microscope operated at an acceleration voltage of 100 kV. According to the present invention it is more preferred that the mean particle size d50 as well as the particle sizes d90 and d10 as used herein are determined according to the method described herein under characterization methods in the experimental section.

In the context of the present invention, the mean particle d50, and the particle sizes d10 and d90 of the transition metal nanoparticles preferably do not include particles located within 10 nm of the edges of the zeolite crystals, preferably within 30 nm, more preferably within 50 nm, more preferably within 100 nm, more preferably within 150 nm, and more preferably within 200 nm of the edges of the zeolite crystals,

wherein the edges of the zeolite crystals are those which comprise the smallest dimension of the zeolite crystals, wherein preferably the zeolite crystals have a platelet type or sheet-like morphology, and the edges of the zeolite crystals are the edges of the platelets or sheets which constitute the zeolite crystal morphology.

In the context of the present invention, while there are no specific restrictions for the transition metal, it is preferred that the transition metal of the transition metal nanoparticles is selected from groups 8 to 11 of the periodic table, including mixtures and/or alloys of two or more thereof, preferably from the group consisting of Fe, Co, Ni, Cu, Rh, Pd, Ag, Pt, Au, and mixtures and/or alloys of two or more thereof, more preferably from the group consisting of Fe, Cu, Rh, Pd, Pt, and mixtures and/or alloys of two or more thereof, more preferably from the group consisting of Rh, Pd, Pt, and mixtures and/or alloys of two or more thereof, wherein more preferably the transition metal comprises Pd, and wherein more preferably the transition metal is Pd. Preferably, the transition metal nanoparticles are in elemental form. In this context, the term “elemental form” means having the oxidation state 0.

While there are no specific restrictions, in the zeolite containing transition metal nanoparticles it is preferred that the zeolite has a framework type selected from the group consisting of FER, MWW, SOD, RWR, CDO, and RRO, wherein preferably the zeolite is of the FER or MWW framework type, wherein more preferably the zeolite is of the FER framework type. Preferably, the zeolite is selected from the group consisting of ZSM-35, sodalite, RUB-24, RUB-37, RUB-41, and MCM-22, wherein preferably the zeolite is ZSM-35 or MCM-22, wherein more preferably the zeolite is ZSM-35.

Preferably, the zeolite contains 5 wt.-% or less of non-framework elements other than the transition metal nanoparticles calculated as the element and based on 100 wt.-% of the total weight of X, Y, O, and of the transition metal contained in the zeolite calculated as the respective element, preferably 1 wt.-% or less, more preferably 0.5 wt.-% or less, more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt.-% or less, and more preferably 0.0001 wt.-% or less. The wt.-% as used herein is preferably as determined by Inductively coupled plasma atomic emission spectroscopy (ICP-AES). non-framework elements are selected from the group consisting of Na, K, C, and N, more preferably of Na, K, Mg, Ca, transition metals, C, and N, more preferably of Na, K, Rb, Cs, Mg, Ca, Sr, Ba, transition metals, B, C, N, and S, and more preferably from the group consisting of alkali metals, alkaline earth metals, transition metals, B, C, N, and S.

According to the present application, the term “non-framework elements” designate elements which do not constitute the framework structure and are accordingly present in the pores and/or cavities formed by the framework structure and are typical for zeolites in general.

In the context of the present invention Y may be any tetravalent element. Preferably, the tetravalent element Y is selected from the group consisting of Si, Sn, Ti, Zr, Ge, and mixtures of two or more thereof, Y preferably being Si.

In the context of the present invention X may be any trivalent element. Preferably the trivalent element X is selected from the group consisting of Al, B, In, Ga, and mixtures of two or more thereof, X preferably being Al.

While there are no specific restrictions, it is preferred that the zeolite displays a YO₂:X₂O₃ molar ratio in the range of from 2 to 300, preferably from 4 to 200, more preferably from 6 to 150, more preferably from 8 to 100, more preferably from 12 to 70, more preferably from 14 to 50, more preferably from 16 to 40, more preferably from 18 to 35, more preferably from 20 to 30, and more preferably from 22 to 26.

Furthermore, preferably the zeolite displays a BET surface area determined according to ISO 9277:2010 in the range of from 100 to 550 m²/g, preferably of from 150 to 500 m²/g, more preferably of from 200 to 450 m²/g, more preferably of from 250 to 400 m²/g, and even more preferably of from 300 to 350 m²/g.

Depending on the intended use of the zeolite containing transition metal nanoparticles, the zeolite, preferably obtained from (iv) or (v) can be employed as such. Further, it is conceivable that this zeolite is subjected to one or more further post-treatment steps. For example, the zeolite which is more preferably obtained as a powder can be suitably processed to a molding or a shaped body by any suitably method, including, but no restricted to, extruding, tableting, spraying and the like. Preferably, the shaped body may have a rectangular, a triangular, a hexagonal, a square, an oval or a circular cross section, and/or preferably is in the form of a star, a tablet, a sphere, a cylinder, a strand, or a hollow cylinder. When preparing a shaped body, one or more binders can be used which may be chosen according to the intended use of the shaped body.

Possible binder materials include, but are not restricted to, graphite, silica, titania, zirconia, alumina, and a mixed oxide of two or more of silicon, titanium and zirconium. The weight ratio of the zeolite relative to the binder is generally not subject to any specific restrictions and may be, for example, in the range of from 10:1 to 1:10. According to a further example according to which the zeolite is used, for example, as a catalyst or as a catalyst component for treating an exhaust gas stream, for example an exhaust gas stream of an engine, it is possible that the obtained zeolite is used as a component of a washcoat to be applied onto a suitable substrate, such as a wall-flow filter or the like.

The transition metal containing zeolite can be used for any conceivable purpose, including, but not limited to, a molecular sieve, catalyst, catalyst component, catalyst support, absorbents, and/or for ion-exchange, preferably as a catalyst, more preferably as a hydrogenation catalyst, or an intermediate for preparing one or more thereof.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.
1. A process for the production of a transition metal containing zeolite comprising:
   (i) providing a layered silicate;
   (ii) treating the layered silicate provided in (i) with one or more swelling agents and obtaining an interlayer expanded silicate;
   (iii) treating the interlayer expanded silicate obtained in (ii) with one or more cationic transition metal complexes and obtaining a transition metal containing interlayer expanded silicate;
   (iv) calcining the transition metal containing interlayer expanded silicate obtained in (iii) and obtaining a transition metal containing zeolite;
   (v) optionally reducing the transition metal containing zeolite obtained in (iv);
wherein the framework structure of the zeolite obtained in (iv) comprises YO₂ and optionally X₂O₃, wherein Y is a tetravalent element, and X is a trivalent element.
2. The process of embodiment 1, wherein the tetravalent element Y is selected from the group consisting of Si, Sn, Ti, Zr, Ge, and mixtures of two or more thereof, Y preferably being Si.
3. The process of embodiment 1 or 2, wherein the trivalent element X is selected from the group consisting of Al, B, In, Ga, and mixtures of two or more thereof, X preferably being Al.
4. The process of any of embodiments 1 to 3, wherein the layered silicate provided in (i) is a layered aluminosilicate, titanosilicate, or borosilicate, preferably a layered aluminosilicate or titanosilicate, and more preferably a layered aluminosilicate.
5. The process of any of embodiments 1 to 4, wherein the layered silicate provided in (i) is selected from the group consisting of MCM-22P, PREFER, Nu-6(2), PLS-3, PLS-4, MCM-47, ERS-12, MCM-65, RUB-15, RUB-18, RUB-20, RUB-36, RUB-38, RUB-39, RUB-40, RUB-42, RUB-51, BLS-1, BLS-3, ZSM-52, ZSM-55, kanemite, makatite, magadiite, kenyaite, revdite, montmorillonite, and mixtures of two or more thereof, preferably from the group consisting of PREFER, MCM-47, ERS-12, PLS-3, RUB-36, PLS-4, MCM-22P, RUB-15, RUB-18, RUB-39, and mixtures of two or more thereof.
6. The process of any of embodiments 1 to 4, wherein the layered silicate provided in (i) is selected from the group consisting of PREFER, MCM-47, ERS-12, PLS-3, RUB-36, PLS-4, and mixtures of two or more thereof, wherein preferably the layered silicate comprises RUB-36, wherein more preferably the layered silicate is RUB-36.
7. The process of any of embodiments 1 to 4, wherein the transition metal containing zeolite obtained in (iv) is of the FER or CDO framework type, wherein preferably the zeolite is of the FER framework type, wherein more preferably the zeolite obtained in (iv) is ZSM-35.
8. The process of any of embodiments 1 to 4, wherein the layered silicate provided in (i) is RUB-15 and the transition metal containing zeolite is of the SOD framework type, wherein preferably the zeolite obtained in (iv) is sodalite.
9. The process of any of embodiments 1 to 4, wherein the layered silicate provided in (i) is RUB-18 and the transition metal containing zeolite is of the RWR framework type, wherein preferably the zeolite obtained in (iv) is RUB-24.
10. The process of any of embodiments 1 to 4, wherein the layered silicate provided in (i) is RUB-36 and the transition metal containing zeolite is of the CDO framework type, wherein preferably the zeolite obtained in (iv) is RUB-37.
11. The process of any of embodiments 1 to 4, wherein the layered silicate provided in (i) is RUB-39 and the transition metal containing zeolite is of the RRO framework type, wherein preferably the zeolite obtained in (iv) is RUB-41.
12. The process of any of embodiments 1 to 4, wherein the layered silicate provided in (i) is MCM-22P and the transition metal containing zeolite is of the MWW framework type, wherein preferably the zeolite obtained in (iv) is MCM-22.
13. The process of any of embodiments 1 to 4, wherein the transition metal containing zeolite is of the framework type selected from the group consisting of FER, MWW, SOD, RWR, CDO, and RRO, wherein preferably the zeolite is of the FER or MWW framework type, wherein more preferably the zeolite is of the FER framework type.
14. The process of any of embodiments 1 to 4, wherein the transition metal containing zeolite is selected from the group consisting of ZSM-35, sodalite, RUB-24, RUB-37, RUB-41, and MCM-22, wherein preferably the zeolite is ZSM-35 or MCM-22, wherein more preferably the zeolite is ZSM-35.
15. The process of any of embodiments 1 to 14, wherein the transition metal of the one or more cationic transition metal complexes is selected from the group consisting of group 8 to 11 transition metals of the periodic table, including mixtures of two or more thereof, preferably from the group consisting of Fe, Co, Ni, Cu, Rh, Pd, Ag, Pt, Au, and mixtures of two or more thereof, more preferably from the group consisting of Fe, Cu, Rh, Pd, Pt, and mixtures of two or more thereof, more preferably from the group consisting of Rh, Pd, Pt, and mixtures of two or more thereof, wherein more preferably the transition metal of the one or more cationic transition metal complexes comprises Pd, and wherein more preferably the transition metal of the one or more cationic transition metal complexes is Pd.
16. The process of any of embodiments 1 to 15, wherein the treatment in (ii) comprises
   (ii.a) adding the layered silicate to an aqueous solution containing one or more swelling agents, stirring the resulting mixture, and obtaining an interlayer expanded silicate;
   (ii.b) optionally isolating the interlayer expanded silicate obtained in (ii.a), preferably by filtration; and
   (ii.c) optionally washing the interlayer expanded silicate obtained in (ii.a) or (ii.b), preferably in (ii.b); and/or, preferably and
   (ii.d) optionally drying the interlayer expanded silicate obtained in (ii.a), (ii.b) or (ii.c), preferably in (ii.c);
wherein the steps (ii.b) and/or (ii.c) and/or (ii.d) can be conducted in any order, and
wherein optionally one or more of said steps is repeated one or more times;
and wherein the treatment in (iii) comprises
   (iii) treating the interlayer expanded silicate obtained in (ii.a), (ii.b), (ii.c), or (ii.d), preferably in (ii.d), with one or more cationic transition metal complexes and obtaining a transition metal containing interlayer expanded silicate.
17. The process of any of embodiments 1 to 16, wherein the one or more swelling agents used in (ii) or (ii.a) comprise one or more compounds selected from the group consisting of surfactants and mixtures thereof, preferably from the group consisting of cationic surfactants and mixtures thereof, more preferably from the group consisting of quaternary ammonium cations and salts thereof, more preferably from the group consisting of alkyltrimethylammonium compounds, alkylethyldimethylammonium compounds, alkyldiethylmethylammonium compounds, alkyltriethylammonium compounds, and mixtures of two or more thereof, more preferably from the group consisting of alkyltrimethylammonium compounds, alkylethyldimethylammonium compounds, and combinations of two or more thereof, wherein more preferably the one or more swelling agents used in (ii) or (ii.a) comprise one or more alkyltrimethylammonium compounds, wherein more preferably the one or more swelling agents is one or more alkyltrimethylammonium compounds.
18. The process of embodiment 17, wherein the alkyl group is selected from the group consisting of C₄-C₂₆ alkyl chains, preferably from the group consisting of C₆-C₂₄ alkyl chains, more preferably of C₈-C₂₂ alkyl chains, more preferably of C₁₀-C₂₀ alkyl chains, more preferably of C₁₂-C₁₈ alkyl chains, more preferably of C₁₄-C₁₈ alkyl chains, more preferably of C₁₅-C₁₇ alkyl chains, wherein more preferably the alkyl group is a C₁₆ alkyl chain.
19. The process of any of embodiments 1 to 18, wherein the one or more swelling agents used in (ii) or (ii.a) comprise one or more cetyltrimethylammonium salts, wherein the counterion is preferably selected from the group consisting of halides, hydroxide, carboxylates, nitrate, nitrite, sulfate, and mixtures of two or more thereof, more preferably from the group consisting of fluoride, chloride, bromide, hydroxide, nitrate, and mixtures of two or more thereof, more preferably from the group consisting of chloride, bromide, hydroxide and mixtures of two or more thereof, wherein more preferably the one or more swelling agents used in (ii) or (ii.a) comprise cetyltrimethylammonium hydroxide, wherein more preferably the one or more swelling agents used in (ii) or (ii.a) is cetyltrimethylammonium hydroxide.
20. The process of any of embodiments 16 to 19, wherein stirring in (ii.a) is performed for a duration in the range of from 1 to 168 h, preferably from 3 to 144 h, more preferably from 6 to 120 h, more preferably from 12 to 96 h, more preferably from 24 to 72 h, more preferably from 36 to 60 h, more preferably from 42 to 54 h, and more preferably from 46 to 50 h.
21. The process of any of embodiments 16 to 20, wherein washing in (ii.c) is performed with a solvent system comprising water, preferably with water, and more preferably with distilled water.
22. The process of any of embodiments 16 to 21, wherein stirring in (ii.a) and/or drying in (ii.d), preferably stirring and drying, are performed at a temperature in the range of from 20 to 70° C., preferably from 20 to 50° C., more preferably from 20 to 45° C., more preferably from 25 to 40° C., more preferably from 25 to 35° C., and more preferably from 25 to 30° C.
23. The process of any of embodiments 1 to 22, wherein the treatment in (iii) comprises
   (iii.a) preparing a solution comprising one or more cationic transition metal complexes dissolved in one or more alkanols;
   (iii.b) adding the interlayer expanded silicate obtained in (ii) to the solution obtained in (iii.a), stirring the resulting mixture, and obtaining a transition metal containing interlayer expanded silicate;
   (iii.c) optionally isolating the a transition metal containing interlayer expanded silicate obtained in (iii.b), preferably by filtration; and
   (iii.d) optionally washing the transition metal containing interlayer expanded silicate obtained in (iii.b) or (iii.c), preferably in (iii.c); and/or, preferably and
   (iii.e) optionally drying the transition metal containing interlayer expanded silicate obtained in (iii.b), (iii.c) or (iii.d), preferably in (iii.d);
wherein the steps (iii.c) and/or (iii.d) and/or (iii.e) can be conducted in any order, and
wherein optionally one or more of said steps is repeated one or more times;
and wherein the treatment in (iv) comprises
   (iv) calcining the transition metal containing interlayer expanded silicate obtained in (iii.b), (iii.c), (iii.d), or (iii.e), preferably in (ii.e), and obtaining a transition metal containing zeolite.
24. The process of embodiment 23, wherein the ligands of the one or more cationic transition metal complexes are selected from the group consisting of mono-, bi-, tri-, tetra-, penta-, and hexadentate ligands, including combinations of two or more thereof, preferably from the group consisting of halide, pseudohalide, H₂O, NH₃, CO, hydroxide, oxalate, ethylenediamine, 2,2′-bipyridine, 1,10-phenanthroline, acetylacetonate, 2,2,2-crypt, diethylenetriamine, dimethylglyoximate, EDTA, ethylenediaminetriacetate, glycinate, triethylenetetramine, tris(2-aminoethyl)amine, and combinations of two or more thereof, more preferably from the group consisting of fluoride, chloride, bromide, cyanide, cyanate, thiocyanate, NH₃, CO, hydroxide, oxalate, ethylenediamine, acetylacetonate, diethylenetriamine, dimethylglyoximate, EDTA, ethylenediaminetriacetate, glycinate, triethylenetetramine, tris(2-aminoethyl)amine, and combinations of two or more thereof, more preferably from the group consisting of ethylenediamine, acetylacetonate, diethylenetriamine, EDTA, ethylenediaminetriacetate, triethylenetetramine, and combinations of two or more thereof, wherein more preferably the ligand of the one or more cationic transition metal complexes is ethylenediamine.
25. The process of embodiment 23 or 24, wherein the counterion of the one or more cationic transition metal complexes is selected from the group consisting of halides, hydroxide, carboxylates, nitrate, nitrite, sulfate, and mixtures of two or more thereof, more preferably from the group consisting of bromide, acetate, formate, nitrate, nitrite, sulfate, and mixtures of two or more thereof, more preferably from the group consisting of acetate, formate, nitrate, and mixtures of two or more thereof, wherein more preferably the counterion of the one or more cationic transition metal complexes comprises acetate, wherein more preferably the counterion of the one or more cationic transition metal complexes is acetate.
26. The process of any of embodiments 23 to 25, wherein the one or more alkanols in (iii.a) are selected from the group consisting of methanol, ethanol, n-propanol, isopropanol, n-butanol, and mixtures of two or more thereof, preferably from the group consisting of methanol, ethanol, isopropanol, and mixtures of two or more thereof, wherein more preferably the one or more alkanols in (iii.a) comprise ethanol, wherein more preferably ethanol is used as the one or more alkanols in (iii.a).
27. The process of any of embodiments 23 to 26, wherein the solution prepared in (iii.a) further comprises excess ligands of the one or more cationic transition metal complexes, preferably excess ligands and excess counterions of the one or more cationic transition metal complexes, and more preferably excess ligands and excess counterions, wherein the excess counterions are in the protonated form.
28. The process of any of embodiments 23 to 27, wherein the solution prepared in (iii.a) further comprises water, preferably distilled water.
29. The process of any of embodiments 23 to 28, wherein stirring in (iii.b) is performed for a duration in the range of from 0.5 to 12 h, preferably from 1 to 9 h, more preferably from 1.5 to 7 h, more preferably from 2 to 6 h, more preferably from 2.5 to 5.5 h, more preferably from 3 to 5 h, and more preferably from 3.5 to 4.5 h.
30. The process of any of embodiments 23 to 29, wherein washing in (iii.d) is performed with a solvent system comprising water, preferably with water, and more preferably with distilled water, wherein more preferably washing is first performed with water and subsequently with a solvent selected from the group consisting of methanol, ethanol, n-propanol, isopropanol, n-butanol, and mixtures of two or more thereof, wherein more preferably washing is first performed with distilled water and subsequently with a solvent selected from the group consisting of methanol, ethanol, isopropanol, and mixtures of two or more thereof, wherein more preferably washing is first performed with distilled water and subsequently with ethanol.
31. The process of any of embodiments 23 to 30, wherein stirring in (iii.b) and/or drying in (iii.e), preferably stirring and drying, are performed at a temperature in the range of from 20 to 70° C., preferably from 20 to 50° C., more preferably from 20 to 45° C., more preferably from 25 to 40° C., more preferably from 25 to 35° C., and more preferably from 25 to 30° C.
32. The process of any of embodiments 1 to 31, wherein calcining in (iv) is performed at a temperature in the range of from 250 to 850° C., preferably of from 350 to 750° C., more preferably of from 450 to 650° C., more preferably of from 460 to 600° C., more preferably of from 470 to 560° C., more preferably of from 480 to 540° C., and even more preferably of from 490 to 520° C.
33. The process of any of embodiments 1 to 32, wherein calcining in (iv) is performed for a duration in the range of from 0.5 to 12 h, preferably from 1 to 9 h, more preferably from 1.5 to 7 h, more preferably from 2 to 6 h, more preferably from 2.5 to 5.5 h, more preferably from 3 to 5 h, and more preferably from 3.5 to 4.5 h.
34. The process of any of embodiments 1 to 33, wherein reducing in (v) comprises contacting the transition metal containing zeolite obtained in (iv) with a reducing agent, preferably with H₂, more preferably with a gas containing one or more inert gases and hydrogen, wherein hydrogen is contained in the gas in an amount in the range of from 1 to 95 vol.-%, preferably of from 5 to 80 vol.-%, more preferably of from 10 to 60 vol.-%, more preferably of from 15 to 50 vol.-%, more preferably of from 20 to 40 vol.-%, more preferably of from 25 to 35 vol.-%,
   and wherein the one or more inert gases is preferably selected from the group consisting of noble gases, CO₂, N₂, and mixtures of two or more thereof, more preferably from the group consisting of He, Ar, N₂, and mixtures of two or more thereof, wherein more preferably the one or more inert gases comprise N₂, wherein more preferably the one or more inert gases is N₂, wherein more preferably the gas consists of one or more inert gases and hydrogen.
35. The process of any of embodiments 1 to 34, wherein reducing in (v) is performed at a temperature in the range of from 250 to 850° C., preferably of from 350 to 750° C., more preferably of from 450 to 650° C., more preferably of from 460 to 600° C., more preferably of from 470 to 560° C., more preferably of from 480 to 540° C., and even more preferably of from 490 to 520° C.
36. The process of any of embodiments 1 to 35, wherein reducing in (v) is performed for a duration in the range of from 0.1 to 12 h, preferably from 0.25 to 8 h, more preferably from 0.5 to 5 h, more preferably from 0.75 to 3 h, more preferably from 1 to 2 h, more preferably from 1 to 1.5 h, and more preferably from 1 to 1.25 h.
37. A transition metal containing zeolite obtainable and/or obtained according to the process of any of embodiments 1 to 36.
38. A zeolite containing transition metal nanoparticles, preferably obtainable and/or obtained according to the process of any of embodiments 1 to 36, wherein the framework structure of the zeolite comprises YO₂ and optionally X₂O₃, wherein Y is a tetravalent element, and X is a trivalent element, and wherein the micropores of the zeolite contain 0.15 to 5 wt.-% of the transition metal nanoparticles calculated as the metal element and based on 100 wt.-% of the total weight of X, Y, O, and of the transition metal contained in the zeolite calculated as the respective element, wherein the mean particle size d50 of the transition metal nanoparticles is in the range of from 0.5 to 4 nm, and wherein the transition metal is selected from groups 8 to 11 of the periodic table, including mixtures and/or alloys of two or more thereof.
39. The zeolite of embodiment 38, wherein the micropores of the zeolite contain 0.2 to 4 wt.-% of the transition metal nanoparticles calculated as the metal element and based on 100 wt.-% of the total weight of X, Y, O, and of the transition metal contained in the zeolite calculated as the respective element, preferably 0.4 to 3 wt.-%, more preferably 0.6 to 2.5 wt.-%, more preferably 0.8 to 2.2 wt.-%, more preferably 1 to 1.9 wt.-%, more preferably 1.1 to 1.7 wt.-%, more preferably 1.2 to 1.6 wt.-%, and more preferably 1.3 to 1.5 wt.-%.
40. The zeolite of embodiment 38 or 39, wherein the mean particle size d50 of the transition metal nanoparticles is in the range of from 0.8 to 3 nm, preferably of from 1 to 2.5 nm, more preferably of from 1.1 to 2 nm, more preferably of from 1.2 to 1.7 nm, and more preferably of from 1.3 to 1.5 nm.
41. The zeolite any of embodiments 38 to 40, wherein the particle size d90 of the transition metal nanoparticles is in the range of from 1 to 7 nm, preferably of from 1.1 to 5 nm, more preferably of from 1.2 to 4 nm, more preferably of from 1.3 to 3 nm, more preferably of from 1.4 to 2.5 nm, more preferably of from 1.5 to 2 nm, and more preferably of from 1.6 to 1.8 nm.
42. The zeolite of any of embodiments 38 to 41, wherein the particle size d10 of the transition metal nanoparticles is in the range of from 0.3 to 2.5 nm, preferably of from 0.5 to 2 nm, more preferably of from 0.6 to 1.5 nm, more preferably of from 0.7 to 1.3 nm, more preferably of from 0.8 to 1.2 nm, and more preferably of from 0.9 to 1.1 nm.
43. The zeolite of any of embodiments 38 to 42, wherein the mean particle size d50, and the particle sizes d10 and d90 of the transition metal nanoparticles do not include particles located within 10 nm of the edges of the zeolite crystals, preferably within 30 nm, more preferably within 50 nm, more preferably within 100 nm, more preferably within 150 nm, and more preferably within 200 nm of the edges of the zeolite crystals,
wherein the edges of the zeolite crystals are those which comprise the smallest dimension of the zeolite crystals, wherein preferably the zeolite crystals have a platelet type or sheet-like morphology, and the edges of the zeolite crystals are the edges of the platelets or sheets which constitute the zeolite crystal morphology.
44. The zeolite of any of embodiments 38 to 43, wherein the transition metal of the transition metal nanoparticles is selected from groups 8 to 11 of the periodic table, including mixtures and/or alloys of two or more thereof, preferably from the group consisting of Fe, Co, Ni, Cu, Rh, Pd, Ag, Pt, Au, and mixtures and/or alloys of two or more thereof, more preferably from the group consisting of Fe, Cu, Rh, Pd, Pt, and mixtures and/or alloys of two or more thereof, more preferably from the group consisting of Rh, Pd, Pt, and mixtures and/or alloys of two or more thereof, wherein more preferably the transition metal comprises Pd, and wherein more preferably the transition metal is Pd.
45. The zeolite of any of embodiments 38 to 44, wherein the transition metal nanoparticles are in elemental form.
46. The zeolite of any of embodiments 38 to 45, wherein the zeolite has a framework type selected from the group consisting of FER, MWW, SOD, RWR, CDO, and RRO, wherein preferably the zeolite is of the FER or MWW framework type, wherein more preferably the zeolite is of the FER framework type.
47. The zeolite of any of embodiments 38 to 46, wherein the zeolite is selected from the group consisting of ZSM-35, sodalite, RUB-24, RUB-37, RUB-41, and MCM-22, wherein preferably the zeolite is ZSM-35 or MCM-22, wherein more preferably the zeolite is ZSM-35.
48. The zeolite of any of embodiments 38 to 47, wherein the zeolite contains 5 wt.-% or less of non-framework elements other than the transition metal nanoparticles calculated as the element and based on 100 wt.-% of the total weight of X, Y, O, and of the transition metal contained in the zeolite calculated as the respective element, preferably 1 wt.-% or less, more preferably 0.5 wt.-% or less, more preferably 0.1 wt.-% or less, more preferably 0.05 wt.-% or less, more preferably 0.01 wt.-% or less, more preferably 0.005 wt.-% or less, more preferably 0.001 wt.-% or less, more preferably 0.0005 wt.-% or less, and more preferably 0.0001 wt.-% or less.
49. The zeolite of embodiment 48, wherein the non-framework elements are selected from the group consisting of Na, K, C, and N, preferably of Na, K, Mg, Ca, transition metals, C, and N, more preferably of Na, K, Rb, Cs, Mg, Ca, Sr, Ba, transition metals, B, C, N, and S, and more preferably from the group consisting of alkali metals, alkaline earth metals, transition metals, B, C, N, and S.
50. The zeolite of any of embodiments 38 to 49, wherein the tetravalent element Y is selected from the group consisting of Si, Sn, Ti, Zr, Ge, and mixtures of two or more thereof, Y preferably being Si.
51. The zeolite of any of embodiments 38 to 50, wherein the trivalent element X is selected from the group consisting of Al, B, In, Ga, and mixtures of two or more thereof, X preferably being Al.
52. The zeolite of any of embodiments 38 to 51, wherein the zeolite displays a YO₂:X₂O₃ molar ratio in the range of from 2 to 300, preferably from 4 to 200, more preferably from 6 to 150, more preferably from 8 to 100, more preferably from 12 to 70, more preferably from 14 to 50, more preferably from 16 to 40, more preferably from 18 to 35, more preferably from 20 to 30, and more preferably from 22 to 26.
53. The zeolite of any of embodiments 38 to 52, wherein the zeolite displays a BET surface area determined according to ISO 9277:2010 in the range of from 100 to 550 m²/g, preferably of from 150 to 500 m²/g, more preferably of from 200 to 450 m²/g, more preferably of from 250 to 400 m²/g, and even more preferably of from 300 to 350 m²/g.
54. Use of a transition metal containing zeolite according to any of embodiments 37 to 53 as a molecular sieve, catalyst, catalyst component, catalyst support, absorbents, and/or for ion-exchange, preferably as a catalyst, more preferably as a hydrogenation catalyst.

### DESCRIPTION OF THE FIGURES

FIG. 1 shows the X-ray diffraction patterns of (a) RUB-36; (b) swollen RUB-36; (c) deswollen material obtained by ion exchange with Pd(en)₂²⁺; (d) Pd@ZSM-35 obtained after calcination and H₂ reduction according to Example 1. In the figure, the angle 2 theta in degrees is shown along the abscissa and the intensities are plotted along the ordinate.

FIG. 2 shows the TEM in figures (a) and (b) and the STEM in figure (c) of the Pd@ZSM-35 obtained after calcination and H₂ reduction according to Example 1.

FIG. 3 shows the particle size distribution of the Pd nanoparticles in Pd@ZSM-35 obtained after calcination and H₂ reduction according to Example 1 as determined from the TEM images. In the figure, the particle size in nm is shown along the abscissa and the distribution in % is plotted along the ordinate.

### EXAMPLES

### Characterization Methods

XRD patterns were collected on the PANalytical X'Pert3 Powder X-ray diffractometer with Cu K_{α} radiation in the 2θ range of 0.5-10° and 5-50° and scan step size of 0.026°.

Nitrogen adsorption/desorption measurements were carried out on a Micromeritics 2020 analyzer at 77 K after the samples were degassed at 350° C. under vacuum.

Pd contents of the resulted catalysts were determined by Inductively Coupled Plasma Atomic Emission Spectroscopy (ICP-AES, Optima 2000 DV, USA).

SEM and STEM images were obtained using a Hitachi S-5500 SEM equipped with a scanning transmission electron microscope (STEM), operating at an accelerating voltage of 30 kV.

Transmission electron microscopy (TEM) images were recorded on Hitachi HT 7700 microscope operated at an acceleration voltage of 100 kV. The mean particle size (d50) of the palladium nanoparticles in the samples was determined by analysis of a 100×100 nm area in the TEM image of a given sample. More specifically, the size (diameter) of the particles within that area was measured according to the scale bar with a margin of error of ±0.2 nm, wherein the threshold for the determination of the particles was a size of 0.8 nm. Thus, only particles having a diameter 0.8 nm or greater were taken into consideration for the determination of the particle size distribution and the calculation of the mean particle size. For the measurement of non-spheroidal nanoparticles, the largest dimension was recorded as the particle diameter. The mean particle size determined was accordingly the mean particle size by number.

### Reference Example 1: Preparation of diethylenediamine palladium (II) acetate (Pd(en)₂(Ac)₂) and Ethylenediamine Acetic Acid (En-HAc) Solutions

0.3 g palladium acetate (Aladdin Reagent) was dispersed into 9 ml ethanol containing 0.5 g ethylenediamine (Tianjin Bodi Chemical Co., Ltd.). After sonification for 10 min, a clear ethanol solution of Pd(en)₂(Ac)₂ was obtained.

1.0 g acetic acid (Tianjin Fuyu Fine Chemical Co., Ltd.) was dissolved into 9.0 ml ethanol containing 1.0 g ethylenediamine and 0.6 g deionized H₂O to get a clear solution of en-HAc.

### Example 1: Preparation of ZSM-35 Encapsulating Pd Nanoparticles (Pd@ZSM-35)

The layered silicate RUB-36 was prepared as respectively described in W. M. H. Sachtler, Acc. Chem. Res., 1993, 26, 383-387 and N. Wang et al., J. Am. Chem. Soc., 2016, 138, 7484-7487, using diethyldimethylammonium hydroxide as the structure-directing agent (DEDMAOH, 20 wt % solution in water, Sachem Inc.). In general, it was crystallized from the gel with a composition of SiO₂:0.5 SDA:10H₂O. Aerosil 200 was utilized as the silica source. Crystallization was carried out in an autoclave without stirring for 14 days. The resulting product was filtered, washed with deionized water and dried at 100° C.

RUB-36 was then swollen using cetyltrimethylammonium hydroxide (CTAOH, 10 wt % solution in water, TCI) at room temperature (RT). More specifically, 0.5 g RUB-36 was dispersed in 35.0 g CTAOH solution (4 wt % solution in water). The mixture was stirred for 48 h, then filtered and washed with deionized water, and finally dried at RT to obtain an interlayer expanded silicate. The deswelling process with Pd(en)₂Ac₂ was conducted by mixing 0.5 g swollen sample with a mixture of 10 ml ethanol, 0.31 ml Pd(en)₂Ac₂ solution and 1.25 ml en-HAc solution from Reference Example 1, respectively, then stirred for 4 h at RT. The transition metal containing interlayer expanded silicate product was recovered by filtration, repeated washing with deionized water and ethanol, and then dried at RT. Calcination of the obtained sample was conducted at 500° C. in static air for 4 h. The calcined sample was then reduced at 330° C. under 30 ml/min 30% H₂/N₂ for 1 h for obtaining ZSM-35 encapsulating Pd nanoparticles (Pd@ZSM-35).

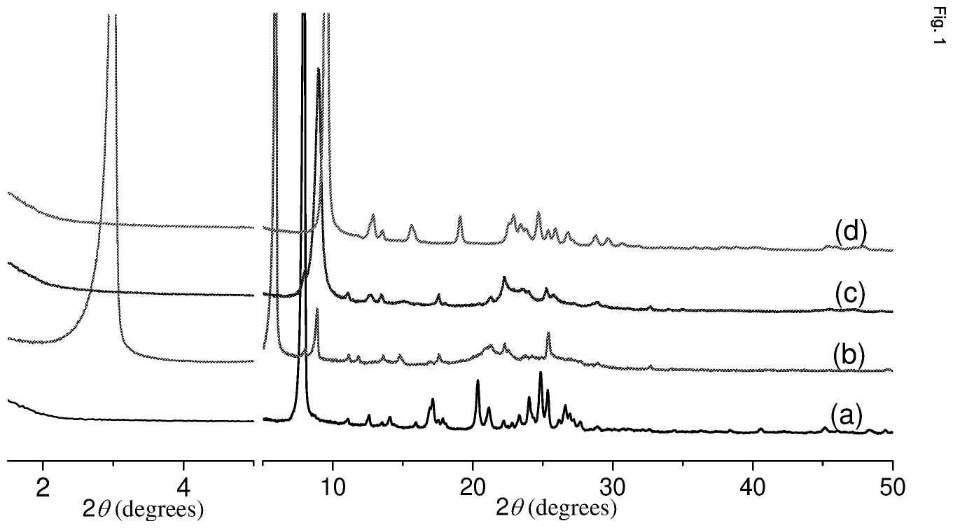

As shown in FIG. 1, after calcination in air and reduction with hydrogen, the obtained Pd@FER (see XRD pattern (d)) has the same diffraction pattern as FER zeolite with very good crystallinity. Moreover, the absence of the diffractions of Pd metal crystals near 40.1° and 46.6° means that Pd metal nanoparticles are ultrafine without significant aggregated bulk ones. ICP-AES analysis shows that the Pd loading amount is 1.4 wt.-% based on the total weight of Si, 0, and Pd in the sample. It's worth noting that the introduction of a too large amount of Pd precursors should be avoided between the FER layers since this may hinder the ordered condensation of the silanol groups between the FER layers. For avoiding this, a certain amount of ethylenediamine-acetic acid (En-HAC) solution was co-added with the Pd precursors during the deswelling process.

N₂ adsorption/desorption isotherms of Pd@FER shows a typical Langmuir-type adsorption, indicating the presence of uniform micropores with a Brunauer-Emmett-Teller (BET) surface area of 325 m²/g.

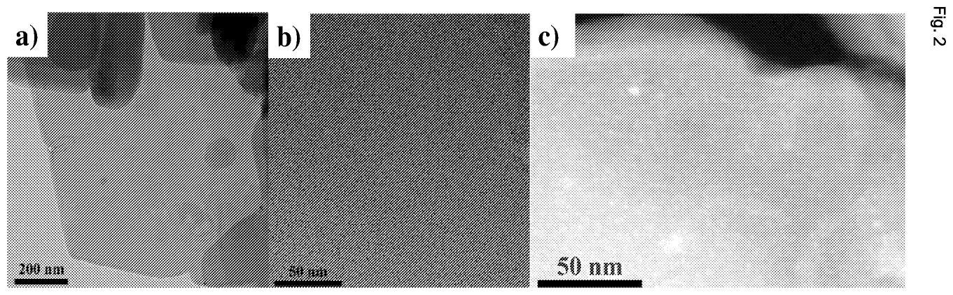

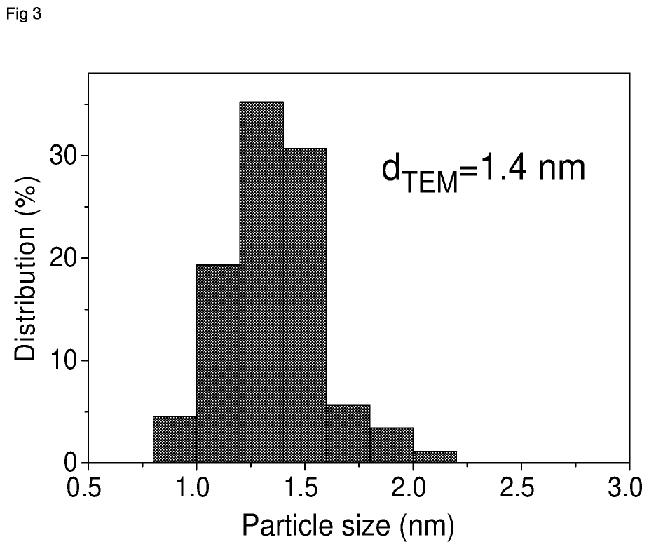

TEM and STEM images shown in FIG. 2 indicate ultrafine and well dispersed Pd nanoparticles with mean particle size of 1.4 nm intensively distributed on the zeolite support, and only very minor bulk ones near the edge of zeolite sheet for Pd@FER, which is reasonable due to the migration of Pd atoms near the edges during high temperature calcination. The particle size distribution of the Pd nanoparticles as obtained from TEM is displayed in FIG. 3.

It's worth noting that the 1.4 nm mean particle size of the Pd nanoparticles embedded in the FER zeolite is actually much larger than the pore diameters of 5.4×4.2 Å and the side-cages (about 7 Å). It can be explained by the fact that both the formation of 3-D zeolite and Pd nanoparticles occurs during the calcination process, and once Pd nanoparticles were formed larger than the pore size before the ordered condensation of silanol groups, the defects may be created. It's also the case when too many Pd(en)₂²⁺ were introduced between the FER layers, as a result of which the ordered FER structure could not be obtained. The homogeneous distribution of Pd nanoparticles with extremely high density in FER zeolite without significant aggregation may result from its distinctive two-dimensional structure. Pd precursors or nanoparticles are separated by the FER layers, which hinders the particle aggregation among different layers, and therefore enhance the stability of Pd nanoparticles.

Therefore, the inventive method allows for the production of zeolites having very high loadings of the transition metal nanoparticles encapsulated within their micropores.

### CITED PRIOR ART LITERATURE

L. Liu et al., Nat Mater, 2017, 16, 132-138
Z. Zhao et al., Chem. Mater., 2013, 25, 840-847
W. M. H. Sachtler, Acc. Chem. Res., 1993, 26, 383-387
N. Wang et al., J. Am. Chem. Soc., 2016, 138, 7484-7487

1. A process for the production of a transition metal-containing zeolite, the process comprising:
(i) providing a layered silicate;
(ii) treating the layered silicate provided in (i) with one or more swelling agents and obtaining an interlayer expanded silicate;
(iii) treating the interlayer expanded silicate obtained in (ii) with one or more cationic transition metal complexes and obtaining a transition metal-containing interlayer expanded silicate;
(iv) calcining the transition metal-containing interlayer expanded silicate obtained in (iii) and obtaining a transition metal-containing zeolite; and
(v) optionally reducing the transition metal-containing zeolite obtained in (iv),
wherein the framework structure of the zeolite obtained in (iv) comprises YO₂ and optionally X₂O₃, wherein Y is a tetravalent element, and X is a trivalent element.

2. The process of claim 1, wherein the tetravalent element Y is at least one selected from the group consisting of Si, Sn, Ti, Zr, Ge, and mixtures thereof.

3. The process of claim 1, wherein the trivalent element X is at least one selected from the group consisting of Al, B, In, Ga, and mixtures thereof.

4. The process of claim 1, wherein the layered silicate provided in (i) is at least one selected from the group consisting of MCM-22P, PREFER, Nu-6(2), PLS-3, PLS-4, MCM-47, ERS-12, MCM-65, RUB-15, RUB-18, RUB-20, RUB-36, RUB-38, RUB-39, RUB-40, RUB-42, RUB-51, BLS-1, BLS-3, ZSM-52, ZSM-55, kanemite, makatite, magadiite, kenyaite, revdite, montmorillonite, and mixtures thereof.

5. The process of claim 1, wherein the transition metal of the one or more cationic transition metal complexes is at least one selected from the group consisting of group 8 to 11 transition metals of the periodic table.

6. A transition metal-containing zeolite obtained according to the process of claim 1.

7. A zeolite comprising transition metal nanoparticles, wherein the framework structure of the zeolite comprises YO₂ and optionally X₂O₃, wherein Y is a tetravalent element, and X is a trivalent element, and wherein the micropores of the zeolite comprise 0.15 to 5 wt.-% of the transition metal nanoparticles calculated as the metal element and based on 100 wt.-% of the total weight of X, Y, O, and of the transition metal contained in the zeolite calculated as the respective element, wherein the mean particle size d50 of the transition metal nanoparticles is in the range of from 0.5 to 4 nm, and wherein the transition metal is at least one selected from groups 8 to 11 of the periodic table.

8. The zeolite of claim 7, wherein the particle size d90 of the transition metal nanoparticles is in the range of from 1 to 7 nm.

9. The zeolite of claim 7, wherein the particle size d10 of the transition metal nanoparticles is in the range of from 0.3 to 2.5 nm.

10. The zeolite of claim 7, wherein the transition metal of the transition metal nanoparticles is at least one selected from groups 8 to 11 of the periodic table, and mixtures and/or alloys thereof.

11. The zeolite of claim 7, wherein the transition metal nanoparticles are in elemental form.

12. The zeolite of claim 7, wherein the zeolite has a framework type selected from the group consisting of FER, MWW, SOD, RWR, CDO, and RRO.

13. The zeolite of claim 7, wherein the tetravalent element Y is at least one selected from the group consisting of Si, Sn, Ti, Zr, Ge, and mixtures thereof.

14. The zeolite of claim 7, wherein the trivalent element X is at least one selected from the group consisting of Al, B, In, Ga, and mixtures thereof.

15. A process, comprising employing a transition metal-containing zeolite according claim 6 as a molecular sieve, catalyst, catalyst component, catalyst support, absorbents, and/or for ion-exchange.
